(19) United States
(12) Patent Application Publication
(10) Pub. No.: US 2011/0286793 A1
(43) Pub. Date: Nov. 24, 2011

(54) PAVER MAT

(75) Inventor: Juan Carlos ARGUELLO, Key Biscayne, FL (US)

(73) Assignee: INTER-MAC VENTURES LLC, Arlington, VA (US)

(21) Appl. No.: 12/785,265

(22) Filed: May 21, 2010

(51) Int. Cl. E01C 11/02; B29C 39/14; E01C 5/00

(52) U.S. Cl. 404/35; 404/41; 404/73; 264/166

(57) ABSTRACT

A paver may include a paver body and at least two slots running through the paver body from one side to another side. The slots may be parallel to an upper surface of the paver body. The slots further may be aligned according to the paver's orientation in a larger paver pattern such that, when multiple pavers are assembled according to the pattern, the slots of individual pavers cooperate to generate extended channels throughout the pattern. Thus, the principles of the present invention permit manufacturers to assemble paver mats made of a plurality of the pavers weaved together by a plurality of fastening cables that fit within one or more extended channels. In one embodiment, a core puller may be used to create slots in the paver body.

### BACKGROUND

Pavers are pre-cast pieces of concrete or brick commonly used for interior flooring or exterior hardscaping applications. The pavers often are manufactured in shapes that can be assembled in interlocking fashion for use as flooring, driveways, walkways, streets and runways. In many situations, pavers provide a superior alternative to poured concrete or asphalt. For example, pavers may provide great resistance to freeze-thaw cracking, better water drainage and need no curing. Further, interlocking pavers can provide better aesthetic appeal than poured concrete or asphalt.

Pavers, however, are expensive to install. Typically, each paver unit must be installed individually and aligned with other pavers according to a paver pattern. Therefore, a need exists for making pavers that can be efficiently laid down and an efficient way to lay pavers.

### BRIEF DESCRIPTION OF THE DRAWINGS

FIG. 1 is a top view of a paver unit according to an embodiment of the present invention.

FIGS. 2A and 2B are two side views of the paver unit of FIG. 1 according to two different embodiments of the present invention.

FIG. 3 is a schematic diagram illustrating a paver mat made of the paver unit of FIG. 1 according to an embodiment of the present invention.

FIGS. 4(a)-4(d) illustrate pavers and paver patterns according to embodiments of the present invention.

FIGS. 5(a)-5(g) illustrate pavers and paver patterns according to embodiments of the present invention.

FIGS. 6(a)-6(g) illustrate another paver and paver patterns according to embodiments of the present invention.

FIGS. 7(a)-7(d) illustrate yet another paver and another paver pattern according to a embodiment of the present invention

FIG. 8 illustrates a process of laying a paver mat according to an embodiment of the present invention.

FIG. 9 is a picture illustrating lifting a paver mat according to an embodiment of the present invention.

FIG. 10 is a picture illustrating the lifted paver mat of FIG. 11 being laid down according to an embodiment of the present invention.

### DETAILED DESCRIPTION

Embodiments of the present invention provide a paver unit that may include a paver body and at least two slots running through the paver body from one side to another side. The slots may be parallel to an upper surface of the paver body. The slots further may be aligned according to the paver's orientation in a larger paver pattern such that, when multiple pavers are assembled according to the pattern, the slots of individual pavers cooperate to generate extended channels throughout the pattern. Thus, the principles of the present invention permit manufacturers to assemble paver mats made of a plurality of the pavers weaved together by a plurality of fastening cables that fit within one or more extended channels.

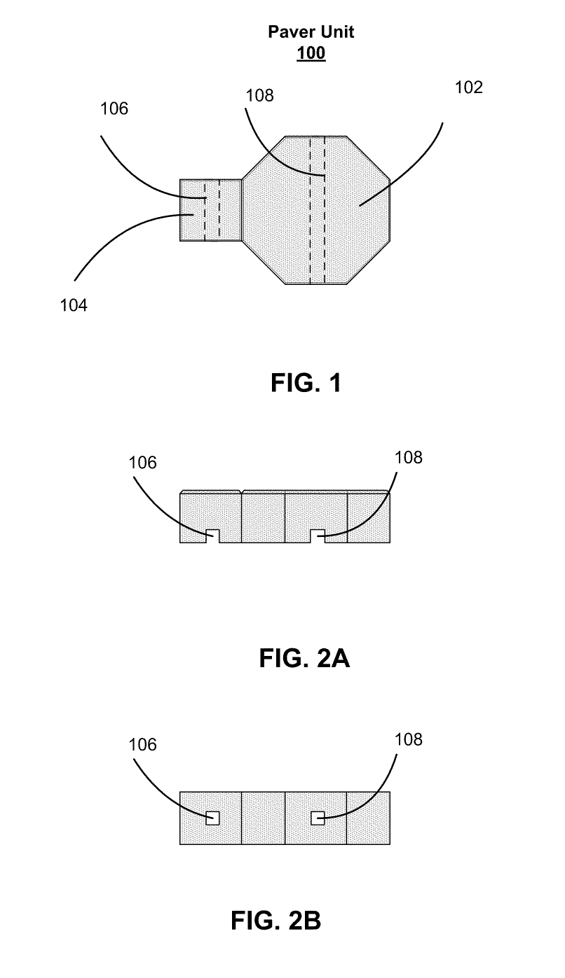

FIG. 1 illustrates a top view of a paver 100 according to an embodiment of the present invention. The paver 100 may include a body having a shape suitable for use in an interlocking pattern. For example, the paver 100 of FIG. 1 is shown as having an octagonal portion 102 and a square tab portion 104. The paver 100 may further may include a plurality of slots 106 and 108 provided either within the paver body or on a rear surface of the paver body. Thus, the two slots 106 and 108 will be imperceptible when the paver unit 102 is viewed from the top (i.e., when it is installed). As discussed below, the slots 106, 108 may be oriented with respect to the paver body so as to form extended channels when multiple pavers are assembled according to the pavers' interlocking pattern.

The paver 100 may be made by a mold with concrete mix. The mold may be in plastic, wood or any other suitable material, either homemade or made in an industrial manufacturing process. In one embodiment, each of the slots 106, 108 may be formed by having a component in the mold to preserve the space for the slot. For example, molded wood/plastic sticks or metal bars may be used for through holes or notches. In another embodiment, the concrete may be stamped to create notches at rear surfaces before it is cured. The stamped notches become the slots when the concrete cures.

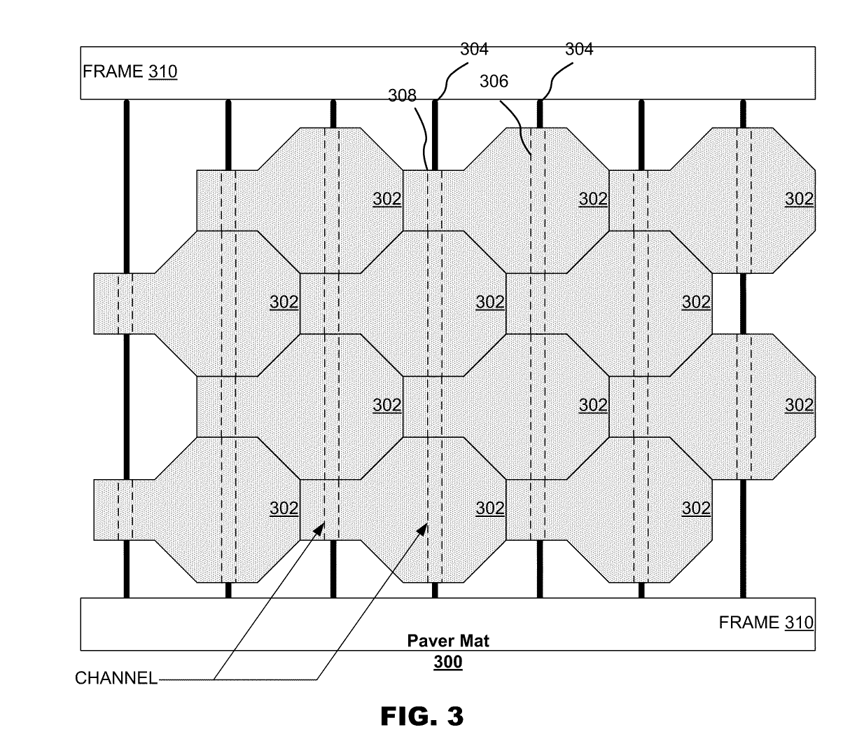

FIGS. 2A and 2B are side views of the paver 100 of FIG. 1 according to two different embodiments of the present invention. As shown in FIG. 2A, in one embodiment, the slots 106 and 108 may be provided as grooves that traverse the rear surface of the paver unit 100. As explained below, the grooves 106, 108 would be exposed when the pavers were assembled for use. FIG. 2B illustrates another embodiment in which the slots 106 and 108 may be two holes through the body of the paver unit 100. In both embodiments, the slots 106 and 108 may be substantially parallel to each other, such that two fastening cables (e.g., two steel cables) may pass through the slots 106 and 108 to weave or chain the paver unit 100 with other paver units into a paver mat.

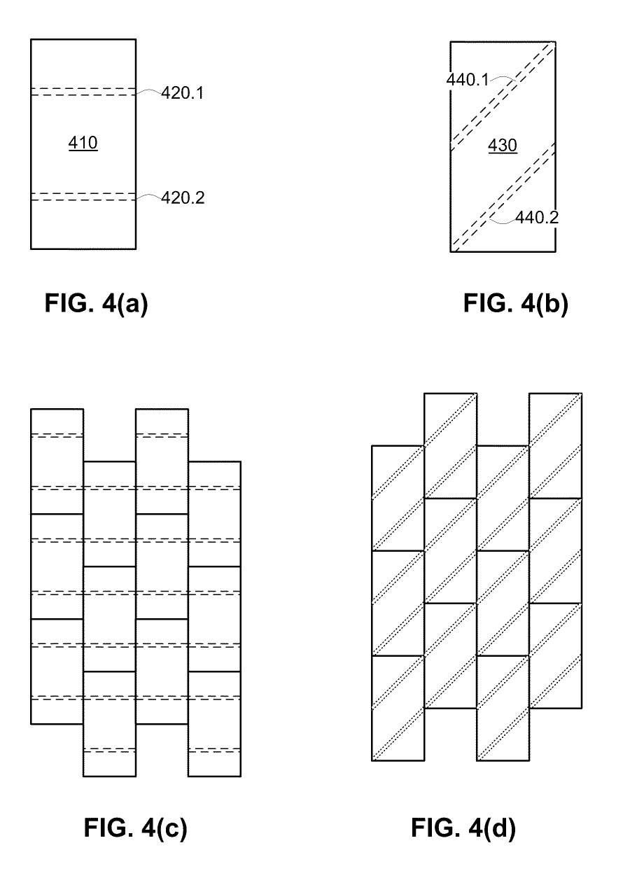

FIG. 3 is a schematic diagram illustrating a paver mat 300 according to an embodiment of the present invention. As shown in FIG. 3, the paver mat 300 may include a plurality of paver units 302 assembled according to the pavers' interlocking pattern. Slots 306, 308 of the various pavers cooperate with each other to form extended channels that run the length or width of the paver mat 300. The mat 300 may include a plurality of fastening cables 304 upon which the pavers 302 may be installed. In the example shown in FIG. 3, a slot 306 of one paver may be aligned with a slot 308 of an adjacent paver. Thus, the fastening cables passing through the extended channels may facilitate interlocking of the adjacent pavers. The fastening cables may be steel cables, rope, fastening straps or any other sturdy connector sufficient to accommodate the weight of the paver mat.

Use of cables 304 allows a paver mat to be pre-assembled, that is, assembled at a site possibly remote from the location at which the pavers will be installed. The paver mat 300 may be shipped to a construction site by a flat bed truck or other convenient apparatus. At a construction site, the paver mats 300 may be hoisted from the track and transferred to a prepared location by a crane or other apparatus. In such a manner, individual installation of many pavers can be avoided.

Assembly of the paver mats 300 can be quite simple. In one embodiment, the cables 304 may be included within a frame assembly of a standard size, for example 5′×10′, 5′×25′ or 5′×40′. Frame members 310 may hold the cables 304 in place with a predetermined spacing between them that matches the channel spacing that will be provided when pavers are placed in location upon the cables 304. Manufacturing personnel may place the pavers 302 on the cables 304 according to the paver pattern. For this use, it may be particularly convenient to use pavers 302 that have slots 306, 308 provided within a rear surface.

In another embodiment, the paver mat 300 may be made by arranging the molds for pavers into the desired pattern and making each paver as part of the paver mat directly. In this embodiment, the fastening cables may be laid among the molds before concrete mix is poured into the molds. In such a manner, the fastening cables may become embedded in the pavers when the concrete cures in the molds. To facilitate removal of the fastening cables after the paver mat is installed, the fastening cables may be wrapped to insulate from the concrete such that the fastening cables will not be fastened to the concrete when it cures. For example, the fastening cables may be wrapped in plastic or paper.

Advantageously, when the assembled paver mats 300 are moved, the weight of the pavers 302 typically causes deformation of the cables 304. In other words, the cables 304 sag under the weight of the pavers 302. The sag effect can help to keep the pavers 302 tightly aligned with respect to each other so that, when the paver mat 300 is positioned at its final installation location, the pavers 302 should be tightly interlocked so that minimal (or no) final alignment is necessary to complete installation.

Once the paver mat 300 is installed, it is permissible to disassemble the frame and withdraw the cables 304 from the pavers 302 by sliding them free. For example, after the frames 310 are disassembled, the cables 304 may be pulled out. In this manner, the frames 310 and cables 304 may be reused.

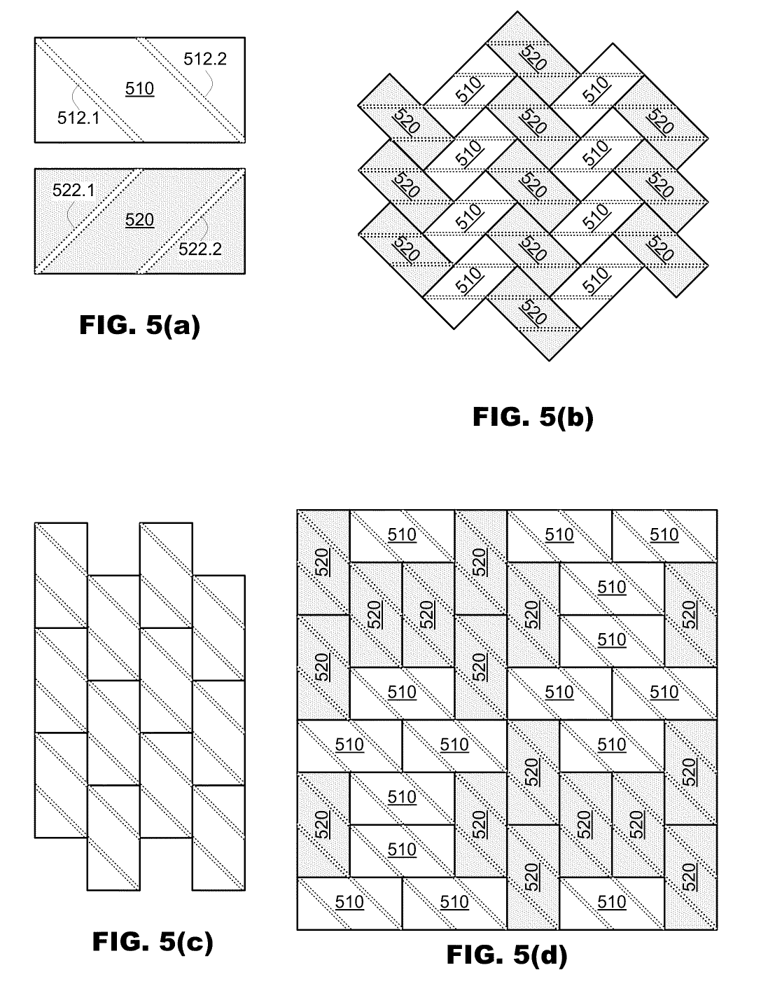

The principles of the present invention extend to pavers of various ornamental configurations and interlocking patterns. FIGS. 4(a) and 4(b) illustrate embodiments in which rectangular pavers are provided with slots to accommodate mat cables. In the example of FIG. 4(a), a paver 410 includes slots 420.1, 420.2 that extend along a width of the rectangular paver 410 at positions at a one-quarter mark and three-quarters mark along the paver's length. In the example of FIG. 4(b), a rectangular paver 430 includes slots 440.1, 440.2 that extend diagonally along the paver's surface with respect to the rectangle's sides. In this example, a first slot 440.1 extends from a first corner of the paver to a midpoint of the paver opposite from the corner. A second slot 440.2 starts at a second corner, diagonally across from the corner of the first slot 440.1, and extends to a midpoint of the paver opposite the second corner. These paver configurations support several different paver patterns. For example, as shown in FIGS. 4(c) and 4(d), both configurations support a running bond pattern.

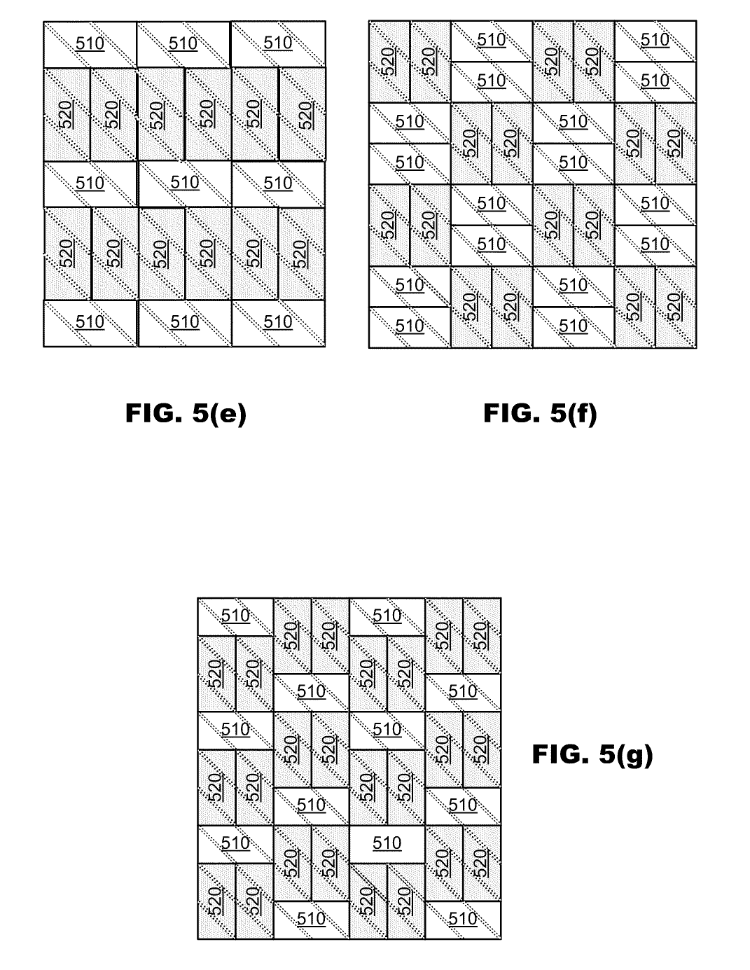

FIG. 5(a) illustrates other embodiments in which rectangular pavers are provided with slots to accommodate fastening cables (e.g., mat cables). The rectangular paver 510 may be similar to the paver 430 shown in FIG. 4(b). The two slots 512.1 and 512.2 of the rectangular paver 510 may each extend from one of two diagonally crossed corners to a midpoint of the paver opposite from the corner. The rectangular paver 520 contains two slots 522.1 and 522.2 oriented to extend from two diagonal crossed corners other than the two corners running through by the slots 512.1 and 512.2 of the paver 510. The configuration of paver 520 also supports a running bond pattern as shown in FIG. 5(c). Further, these pavers 510 and 520 may be combined to support several different paver patterns, for example, a herringbone pattern as shown in FIG. 5(b), a boxed basket pattern as shown in FIG. 5(d), a running and stack pattern as shown in FIG. 5(e), a double basket pattern as shown in FIG. 5(f), and a single basket pattern as shown in FIG. 5(g).

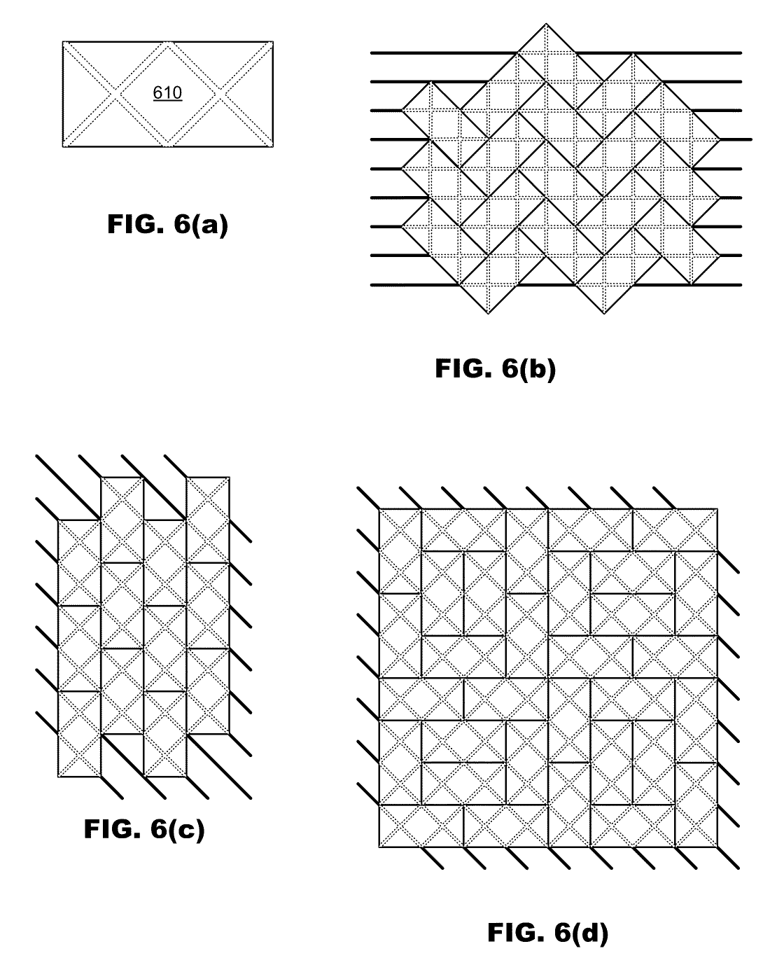

FIG. 6(a) illustrates another embodiment of a rectangular paver that is provided with slots to accommodate mat cables. As shown in FIG. 6(a), the rectangular paver 610 may include four slots extending through all four corners. Each slot may extend from a respective corner to a midpoint of the paver opposite from the respective corner. The slots thus form two crosses. In this manner, paver 610 may support all paver patterns that are supported by the rectangular pavers 510 and 520 respectively, and their combination. For example, paver 610 supports a running bond pattern as shown in FIG. 6(c), a herringbone pattern as shown in FIG. 6(b), a boxed basket pattern as shown in FIG. 6(d), a running and stack pattern as shown in FIG. 6(e), a double basket pattern as shown in FIG. 6(f), and a single basket pattern as shown in FIG. 6(g). As shown in FIGS. 6(b)-6(g), the slots of a plurality of pavers 610 form extended channels in two dimensions in each of the patterns. Although only one dimension is shown to be used by the fastening cables in each of the examples, either dimension may be used. In one embodiment, the width of the rectangular pavers 410, 430, 510, 520 and 610 may be half of their length, and thus two slots forming a cross are orthogonal to each other.

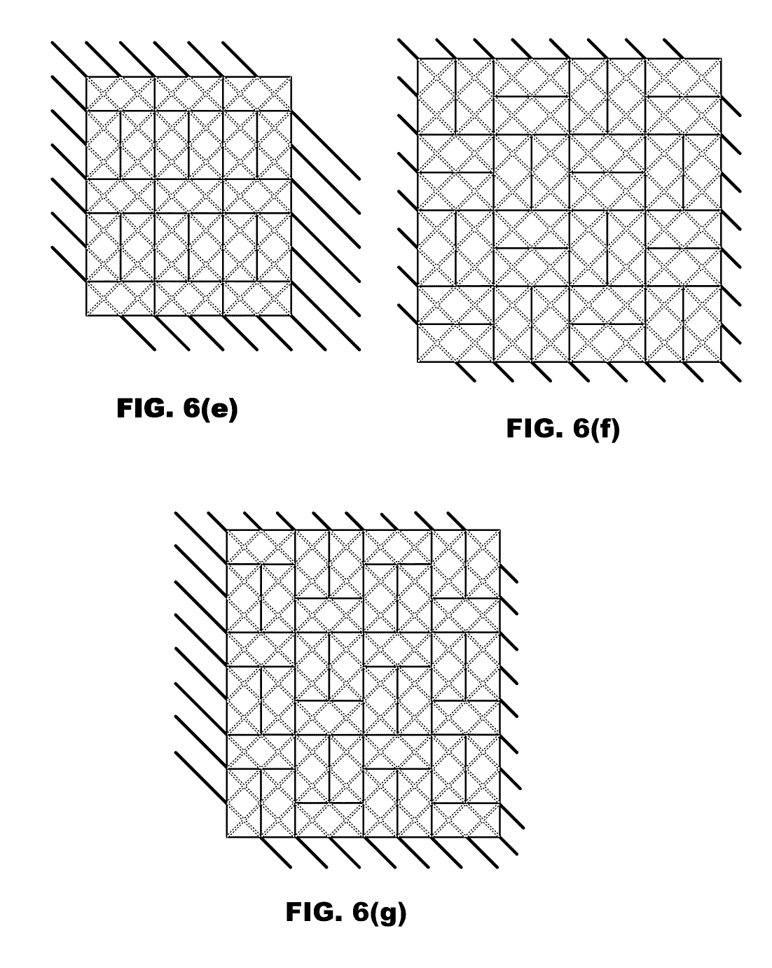

FIG. 7(a) illustrates a top view of a paver 700 according to another embodiment of the present invention. The paver 700 may include a large square body 704 and a square tab 702. In one embodiment, the size of the square tab 702 may be a quarter of the size of the large square body 704 and may be attached to a corner of the large square body 704 as shown in FIG. 7(a). The paver 700 may further include two slots 706 and 708. The two slots 706 and 708 may each traverse the body of the paver 700 from one side to another side and be invisible from the top of the paver 700. Thus, the two slots 706 and 708 are shown in dashed lines. FIG. 7(b) shows that, in one embodiment, the slots 706 and 708 may be two grooves traversing the rear surface of the paver 700. FIG. 7(c) shows that, in another embodiment, the opening slots 706 and 708 may be two holes through the body of the paver 700. In both embodiments, the slots 706 and 708 may be substantially parallel to each other, such that fastening cables (e.g., steel cables) may pass through the slots 706 and 708 to weave or chain the paver unit 700 with other pavers 700 into a paver mat shown in FIG. 7(d).

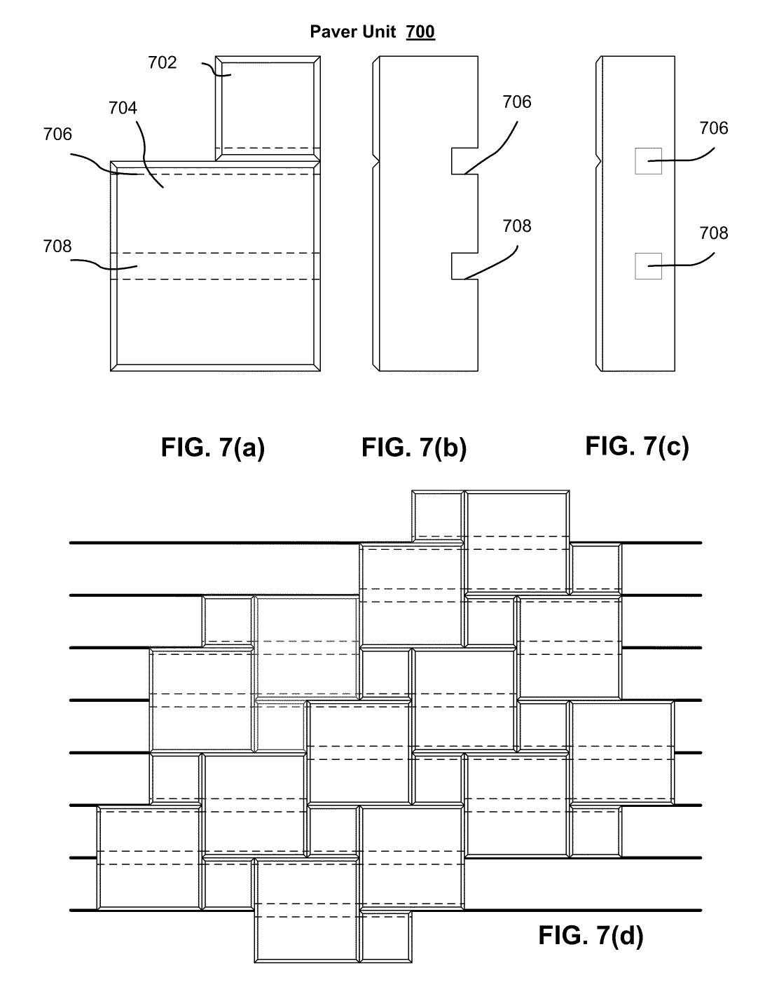

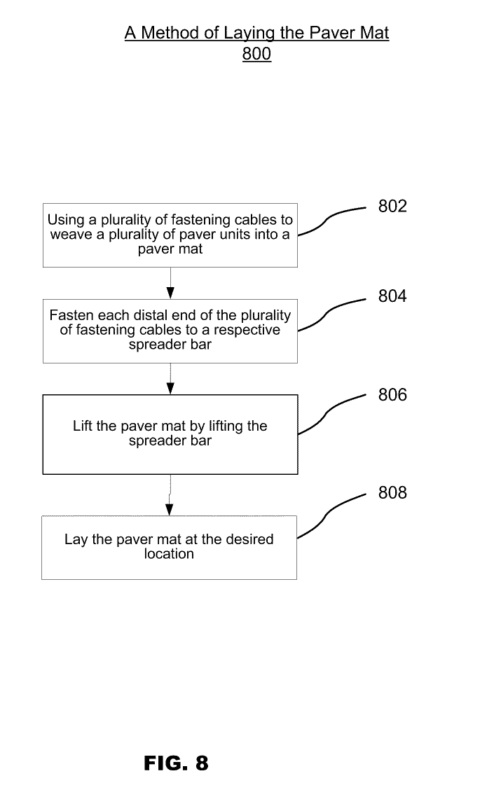

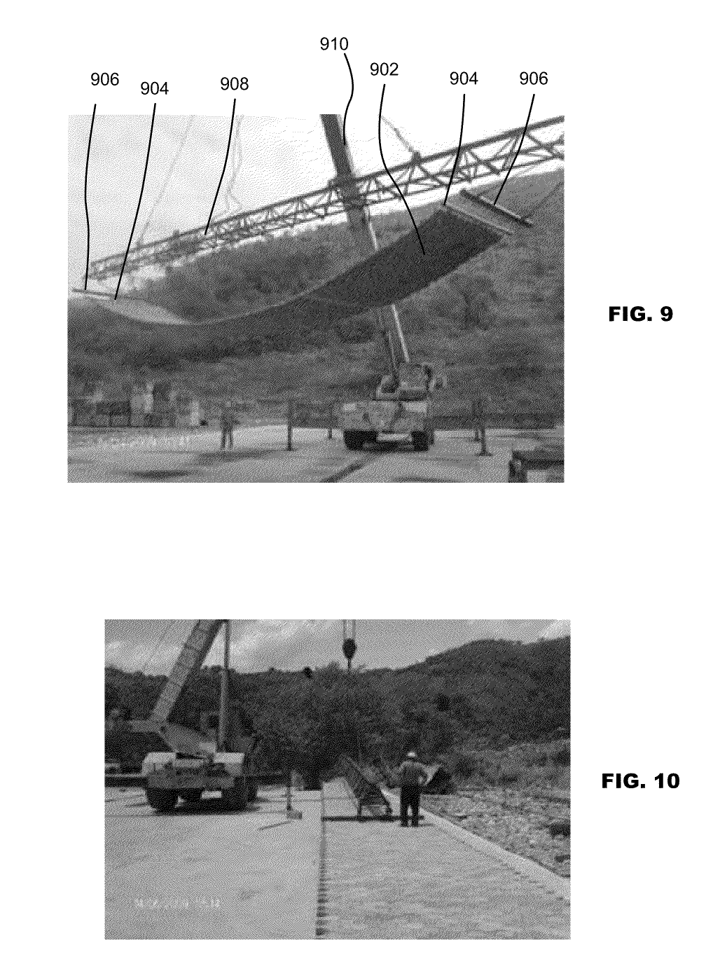

FIG. 8 illustrates a process 800 of laying a paver mat according to an embodiment of the present invention. At 802, a plurality of paver units may be weaved into a paver mat using a plurality of fastening cables. The paver mat may have a desired pattern. At 804, the distal end of each of the plurality of fastening cables may be fastened to a frame respectively. In one embodiment, as shown in FIG. 9, two frames 804 may be positioned at two distal ends of a paver mat 802 and two distal ends of each fastening cable may be fastened to the two frames 804 respectively. At 806, the paver mat may be lifted by lifting the frames. As shown in FIG. 9, each frame 904 may be tied to a lifting bar 906 respectively. The two lifting bars 906 may be tied to a lifting beam 908 at two positions. A lifting arm 910 of a lifting machine, such as a crane, may lift the paver unit 902 by the lifting bars 908 as shown in FIG. 9. At 808, the paver mat may be laid down at a desired location. Typically, a leveled sand base may be prepared at the desired location. For example, FIG. 10 is a picture illustrating the lifted paver mat of FIG. 9 being laid down according to an embodiment of the present invention. In one embodiment, after the paver mat is laid down, the frames and fastening cables may be removed. In another embodiment, the fastening cables may be left in the paver mat after the paver mat is laid down. In these embodiments, the cables may be sufficiently flexible to accommodate settling during installation of the mat and thereby contribute to alignment of the pavers.

The pavers of the present invention may be manufactured by standard masonry manufacturing equipment. In one embodiment, a core puller may be used to create slots in the paver body. A paver mold may be configured to produce a paver unit according to a desired shape, such as the shapes illustrated in the foregoing FIGS. 1, 4 and 7. The combination of the core puller and mold further may include various perforation elements that create voids in the paver body corresponding to the slots described hereinabove. As the paver material is injected into the paver mold, the core puller may be utilized to create material voids in the desired slot locations. Once the core puller has created the slots, the paver may be withdrawn from the mold, and the perforated pavers can be removed from the slot. By way of example, a core puller and paver molds currently commercially available from the Besser Company, Alpena Mich., may be adapted for such purposes.

Several embodiments of the invention are specifically illustrated and/or described herein. However, it will be appreciated that modifications and variations of the invention are covered by the above teachings and within the purview of the appended claims without departing from the spirit and intended scope of the invention.

We claim:

1. A paver, comprising:
a paver body having a shape that accommodates an interlocking paver pattern when multiple pavers are installed, and
at least two slots running through the paver body, oriented within the paver body to form a an extended channel with cooperating slots from other pavers when multiple pavers are assembled according to the paver pattern.

2. The paver of claim 1, wherein the paver body has a rectangular shape.

3. The paver of claim 1, wherein the slots are formed as notches on a bottom surface of the paver body when installed.

4. The paver of claim 1, wherein the slots are formed as holes through the paver body.

5. The paver of claim 1, wherein the slots respectively accommodate a fastening cable that weaves the paver and other pavers into a paver mat.

6. The paver of claim 1, wherein the paver body includes an octagon body and a square tab extending from the octagon body,
wherein the first slot extends through the octagon body from one side to an opposite side, the first slot is parallel to a side of the octagon body attaching the square tab and an upper surface of the paver,
wherein the second slot extends through the square tab from one side to an opposite side, parallel to the first slot.

7. The paver of claim 1, wherein the slots are made by a core puller.

8. A paver mat, comprising:
a plurality of cables, and
a plurality of pavers, each having slots for engagement with the cables when the pavers are assembled according to a predetermined paver pattern.

9. The paver mat of claim 8, wherein the slots of the respective pavers cooperate to form extended channels throughout the plurality of the pavers when the pavers are assembled according to the paver pattern.

10. The paver of claim 8, wherein the slots are formed as notches on a bottom surface of the respective pavers.

11. The paver of claim 8, wherein the slots are formed as holes through the respective pavers.

12. The paver mat of claim 8, further comprising a frame in engagement with the cables to lift the paver mat for installation.

13. The paver mat of claim 8, wherein the cables are removable from the pavers to be reused after the paver mat is installed.

14. The paver mat of claim 8, wherein the cables are sufficiently flexible to accommodate settling during installation of the mat and thereby contribute to alignment of the pavers.

15. The paver mat of claim 11, wherein each of the pavers has an octagon body and a square tab.

16. The paver mat of claim 11, wherein each of the pavers has a rectangular shape.

17. The paver mat of claim 8, wherein the paver pattern is a running bond pattern.

18. The paver mat of claim 8, wherein the paver pattern is a running and stack bond pattern.

19. The paver mat of claim 8, wherein the paver pattern is a herring bone pattern.

20. The paver mat of claim 8, wherein the paver pattern is a double basket weave pattern.

21. The paver mat of claim 8, wherein the paver pattern is a single basket weave pattern.

22. The paver mat of claim 8, wherein the paver pattern is a boxed basket weave pattern.

23. The paver mat of claim 8, wherein the slots are made by a core puller.

24. A method of laying pavers, comprising:
lifting a paver mat by a frame, the paver mat including a plurality of cables and a plurality of pavers assembled according to a paver pattern, the pavers having respective slots that form extended channels through the mat when the pavers are aligned according to the paver pattern, the cables affixed to the frame; and
laying the paver mat at a desired location.

25. The method of claim 24, further comprising removing the frame from the desired location after the laying.

26. The method of claim 24, further comprising removing the cables from the pavers after the laying, without disturbing the pavers.

27. The method of claim 24, wherein the lifting comprising lifting the paver mat from a shipping vehicle.

28. The method of claim 24, wherein the slots of each paver are made by a core puller.

29. A method of making pavers, comprising:
preparing a paver mold in a predetermined shape for a paver body, the shape corresponding to the paver body's contribution to an interlocking paver pattern;
injecting paver material into the paver mold; and
creating slots in the injected paver material before it cures, the slots positioned to form extended channels through the paver pattern when the pavers are aligned according to the paver pattern.

30. The method of claim 29, wherein the slots are created by a core puller machine.
